(19) United States
(12) Patent Application Publication
(10) Pub. No.: US 2025/0131683 A1
(43) Pub. Date: Apr. 24, 2025

(54) IMAGE SCENE SEGMENTATION METHOD AND APPARATUS, AND DEVICE AND STORAGE MEDIUM

(71) Applicant: Beijing Zitiao Network Technology Co., Ltd., Haidian District, Beijing (CN)

(72) Inventors: Yixing Zhu, Beijing (CN); Jiabin Huang, Beijing (CN); Yitong Wang, Beijing (CN)

(21) Appl. No.: 18/730,658

(22) PCT Filed: Jan. 17, 2023
(86) PCT No.: PCT/CN2023/072537

§ 371 Date: Jul. 19, 2024

(30) Foreign Application Priority Data
Jan. 21, 2022 (CN) 202210074188.9

(51) Int. Cl. G06V 10/26; G06V 10/22; G06V 10/80; G06V 10/82

(52) U.S. Cl. CPC G06V 10/26; G06V 10/22; G06V 10/80; G06V 10/82

(57) ABSTRACT

The embodiments of the present disclosure provide an image scene segmentation and apparatus, and a device and a storage medium. The method includes: obtaining an intermediate scene segmentation image by performing scene initial segmentation and scene initial fusion on an obtained target image; detecting, from the intermediate scene segmentation image, segmentation blocks to be processed; and obtaining a target scene segmentation image of the target image by performing segmentation correction on the segmentation blocks to be processed.

The present disclosure claims the priority to the CN patent application Ser. No. 20/221,0074188.9 filed in the China National Intellectual Property Administration on Jan. 21, 2022, the contents of which are hereby incorporated by reference in their entirety.

### FIELD

Embodiments of the present disclosure generally relate to the field of image processing technologies, and more specifically, to an image scene segmentation method and apparatus, a device and a storage medium.

### BACKGROUND

Image scene segmentation, as one of the research directions of image processing, is mainly utilized to separate scenes included in an image according to scene categories. By far, breakthroughs have been achieved in scene and object segmentation based on the deep learning technology.

The deep learning networks for image scene segmentation in the related technologies have obvious achievements in segmenting scenes and objects of a single category or a few categories, which are well-developed. However, the deep learning networks cannot implement accurate segmentation for images including multiple categories of scenes, and typically generate fragmented segmentation results. If such segmentation results are directly applied to downstream services, the execution effect of the downstream services will be affected.

Improvements in the related technologies are mainly focused on direct optimization of the deep learning networks, to thus optimize the scene segmentation results. However, the deep learning networks are heavily dependent on training data sets, but multiple scene categories often have ambiguities therebetween, making it impossible to provide accurate sample data for network training. In addition, more sophisticated deep learning networks have more stringent requirements on the learning capability of the networks and the computing capability of the device, making it difficult to achieve a tradeoff between computing and accuracy.

### SUMMARY

Embodiments of the present disclosure provide an image scene segmentation method and apparatus, a device and a storage medium, to implement optimizing a scene segmentation result while reducing fragmentation of the scene segmentation result.

In a first aspect, embodiments of the present disclosure provide a method of image scene segmentation, comprising:
obtaining an intermediate scene segmentation image by performing scene initial segmentation and scene initial fusion on an obtained target image;
detecting, from the intermediate scene segmentation image, segmentation blocks to be processed; and
obtaining a target scene segmentation image of the target image by performing segmentation correction on the segmentation blocks to be processed.

In a second aspect, the embodiments of the present disclosure further provide an apparatus for image scene segmentation, comprising:
an initial processing module configured to obtain an intermediate scene segmentation image by performing scene initial segmentation and scene initial fusion on an obtained target image;
an information determining module configured to detect, from the intermediate scene segmentation image, segmentation blocks to be processed; and
a segmentation correction module configured to obtain a target scene segmentation image of the target image by performing segmentation correction on the segmentation blocks to be processed.

In a third aspect, the embodiments of the present disclosure further provide an electronic device, comprising:
at least one processor;
a memory storing at least one computer program;
wherein the at least one computer program, when executed by the at least one processor, causes the at least one processor to implement the method of image scene segmentation provided by any embodiment of the present disclosure.

In a fourth aspect, the embodiments of the present disclosure further provide a computer readable storage medium having computer programs stored thereon, wherein the computer programs, when executed by a processor, implement the method of image scene segmentation provided by any embodiment of the present disclosure.

### BRIEF DESCRIPTION OF THE DRAWINGS

FIG. 1 illustrates a flowchart of an image scene segmentation method provided by an Embodiment I of the present disclosure;

FIG. 2 illustrates a flowchart of an image scene segmentation method provided by an Embodiment II of the present disclosure;

FIG. 2a illustrates a structural schematic diagram of a scene segmentation network model utilized for scene initial segmentation in the image scene segmentation method provided by the Embodiment II of the present disclosure;

FIG. 2b illustrates a flowchart of image fusion processing in the image scene segmentation method provided by the Embodiment II of the present disclosure;

FIG. 2c illustrates a rendering of an intermediate scene segmentation image determined in the image scene segmentation method provided by the Embodiment II of the present disclosure;

FIG. 2d illustrates a flowchart of determining segmentation blocks to be processed in the image scene segmentation method provided by the Embodiment II of the present disclosure;

FIG. 2e illustrates an example rendering of displaying the determined segmentation blocks to be processed in the same image according to the Embodiment II of the present disclosure;

FIG. 2f illustrates a flowchart of determining a segmentation layer to which the segmentation blocks to be processed belong in the image scene segmentation method provided by the Embodiment II of the present disclosure;

FIG. 2g illustrates a rendering of a target scene segmentation image in the image scene segmentation method provided by the Embodiment II of the present disclosure;

FIG. 3 is a structural schematic diagram of an image scene segmentation apparatus provided by an Embodiment III of the present disclosure; and

FIG. 4 is a structural schematic diagram of an electronic device provided by an Embodiment VII of the present disclosure.

### DETAILED DESCRIPTION OF EMBODIMENTS

Reference now will be made to the drawings to describe in detail the embodiments of the present disclosure.

It would be appreciated that respective steps in the implementations of the method according to the present disclosure may be performed in different orders and/or performed in parallel. In addition, the method implementations may include additional steps and/or steps omitted. The scope of the present disclosure is not limited thereto.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It should be noted that, the terms “first,” “second” and the like mentioned in the present disclosure are only used to distinguish different apparatuses, modules or units, rather than limit an order of functions performed by the apparatus, module or unit or limit interdependence. It should be noted that, the terms “one” and “a plurality of” mentioned in the present disclosure are illustrative, not restrictive, and should be understood as “at least one” by those skilled in the art, unless explicitly specified otherwise in the context.

Names of messages or information interacted between a plurality of apparatuses in the embodiments of the present disclosure are illustrative rather than limit the scope of the message or information.

### Embodiment I

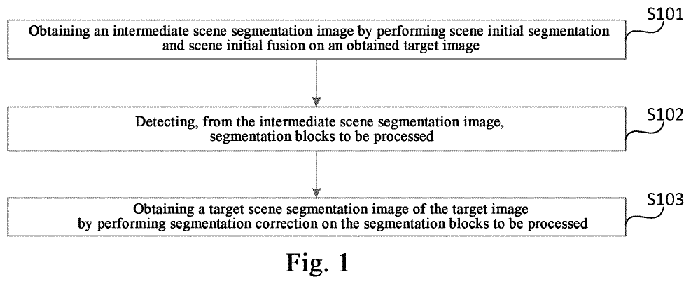

FIG. 1 illustrates a flowchart of an image scene segmentation method provided by the Embodiment I of the present disclosure. The embodiment can be applied to perform image segmentation for an obtained image, and the method can be performed by an image scene segmentation apparatus which can be implemented by software and/or hardware and configured in a terminal and/or a server to implement the image scene segmentation method according to the embodiment of the present disclosure.

As shown in FIG. 1, the image scene segmentation method provided by the Embodiment I includes:

S101: obtaining an intermediate scene segmentation image by performing scene initial segmentation and scene initial fusion on an obtained target image.

In the embodiment, the target image is to be read as an image to be processed through image scene segmentation, which may be a scene image captured in real time, or may be an image frame taken from a captured video stream. In the step, scene initial segmentation may be first performed on the target image. It would be appreciated that, scene segmentation for the image is equivalent to segmenting image contents included in the image according to scene categories to which they belong, so that image contents of the same scene category can be segmented in the same scene image layer. For example, doors or windows in an image can be segmented to a segmentation image layer with a window-door scene category, and vehicles in the image can be segmented to a segmentation image layer with a vehicle scene category.

In the embodiment, a pre-built scene segmentation network model may be used to perform initial scene segmentation on the target image. The pre-built scene segmentation network model can be regarded as a general scene segmentation model, which can be applied to scene segmentation of multiple different scene categories. However, there is not an appropriate setting for granularity of segmentation scene categories, nor is specific limitation provided on applicable application scenarios. Therefore, the initial scene segmentation result obtained through the scene segmentation network model may not be the one required by a downstream service application.

By way of example, it is assumed that the object to be processed by the downstream service application is a building complex. It is required to obtain in advance a scene segmentation image including the building complex only. However, the scene segmentation result after the scene initial segmentation in the step further includes other scene segmentation blocks, or fragmented segmentation blocks with smaller image areas. For example, doors or windows on the buildings may be segmented independently, not in the same scene as the buildings, making it impossible to obtain an accurate segmentation image of the building complex. Therefore, if the initial scene segmentation is performed only on the target image, the downstream service application cannot obtain valid image information.

On the basis, subsequent to performing the scene initial segmentation on the target image, it is also required in the step to perform scene fusion on the image based on the obtained initial scene segmentation result. The scene fusion can be considered as scene initial fusion in the embodiment, and the scene segmentation result after the scene initial fusion is marked as an intermediated scene segmentation image. In the embodiment, a certain fusion rule may be adopted for the segmentation image layer of multiple scene categories included in the initial scene segmentation image to implement initial fusion of images. Wherein, the adopted fusion rule may include fusing the segmentation image layer with a small range of scene categories into a segmentation image layer corresponding to a great range of scene categories.

By way of example, an initial scene segmentation image can be obtained as a result of the scene initial segmentation. Accordingly, scene tags corresponding to the at least one segmentation image layer included in the initial scene segmentation image can be obtained. Then, whether there is a belonging association between the scene tags is analyzed, and the scene segmentation images with the belonging association are fused. For example, for a segmented building-floor segmentation image layer, its scene tag may be building floor, and for a segmented door-window segmentation image layer, its scene label may be door-window. Through analysis of the belonging association between the building floor and the doors and windows, it can be concluded that doors and windows are typically dependent on the building, i.e., the category of the doors and windows is smaller than the category of the building floor in scale. Therefore, the door-window segmentation image layer can be fused with the building floor segmentation layer, to form a new building segmentation image layer.

In the embodiment, with respect to further processing of the scene segmentation image in the following step, the scene fusion of the initial scene segmentation results in this step can be considered as scene initial fusion processing of the scene segmentation result, and the segmentation image layer formed after the scene fusion may constitute a new scene segmentation image, where the new scene segmentation image is marked as an intermediate scene segmentation image in this embodiment.

S102: detecting, from the intermediate scene segmentation image, segmentation blocks to be processed.

In the embodiment, the intermediate scene segmentation image in the step can be considered as a scene segmentation result after performing initial fusion processing on the initial segmentation result corresponding to the target image, which mainly incudes segmentation image layers obtained by performing image content segmentation according to the scene categories, i.e., it can be considered that the image contents included in each segmentation image layer belong to the same scene category, and the scene category can be considered as having a broad range.

It is to be appreciated that the scene segmentation algorithm used for scene initial segmentation of the target image cannot guarantee the accuracy of scene segmentation. Therefore, there is a case where image contents are segmented to a wrong scene category, and through the initial fusion processing, as described above, segmentation of image contents to a wrong scene category cannot be eliminated.

For the segmentation image layer included in the intermediate scene segmentation image, in the event that the scene segmentation is correct, the image content area thereof should be a connected region with a large regional area; if there is other image content region isolated in the connected region with a large regional area, the other image content region isolated is probably a region abnormally scene-segmented, i.e., the segmentation image layer is erroneous in scene segmentation.

In the embodiment, the erroneous scene segmentation region as mentioned above is marked as a segmentation block to be processed, and determining the segmentation block to be processed can be implemented by performing connected region detection on at least one segmentation image layer in the intermediate scene segmentation image. By way of example, in the segmentation image layer including image contents of the same scene category, image connected-region detection can be implemented by scanning pixels in the segmentation image layer, and a region area of each connected region can be determined. If there is a connected region with a regional area less than a threshold, the connected region is used as a segmentation block to be processed in the embodiment.

S103: obtaining a target scene segmentation image of the target image by performing segmentation correction on the segmentation blocks to be processed.

In the embodiment, the detected segmentation block to be processed, as mentioned above, is equivalent to the segmentation block erroneous in scene segmentation. By performing segmentation correction on the segmentation block to be processed in the step, the correct segmentation image layer to which the segmentation block to be processed should belong is determined, and the segmentation block to be processed is fused into the correct segmentation image layer. After all the segmentation blocks to be processed are fused into the respective correct scene segmentation images to which they belong through the above logic, the obtained segmentation image layer forms a target scene segmentation image of the target image.

By way of example, segmentation correction is performed on the segmentation block to be processed, one of the implementations for determining the segmentation layer to which the segmentation block to be processed should belong may be described as follows: expanding regions of the segmentation block to be processed to obtain a segmentation expanded region of the segmentation block to be processed, where the segmentation expanded region includes an overlapping region overlapping with a further determined connected region. In the present embodiment, to what connected region the segmentation block to be processed should belong can be determined based on an overlapping proportion of the further determined connected region in the overlapping region, and the segmentation image layer having the connected region to which it should belong is further determined, and can be used as the segmentation image layer to what the segmentation block to be processed should belong.

The image scene segmentation method provided by the Embodiment I includes: obtaining an intermediate scene segmentation image by performing scene initial segmentation and scene initial fusion on an obtained target image; then determining segmentation blocks to be optimized from the intermediate segmentation image; and finally performing segmentation correction on the segmentation blocks, to obtain a target scene segmentation image of the target image. The above technical solution can solve the problem that the image scene segmentation method according to the related technologies is unable to implement accurate segmentation but generates more fragmented segmentation results. Different from the legacy improved solution, the key to the solution provided by the present embodiment is to perform fragmentation detection on the segmentation result after performing the image scene segmentation, and perform segmentation correction on the detected fragmented segmentation blocks. The corrected segmentation result shows that the present disclosure has the advantageous effect of segmenting image contents in the same scene category in the target image in a concentrated manner, reducing fragmented segmentation blocks, and effectively improving accuracy of the segmentation result.

### Embodiment II

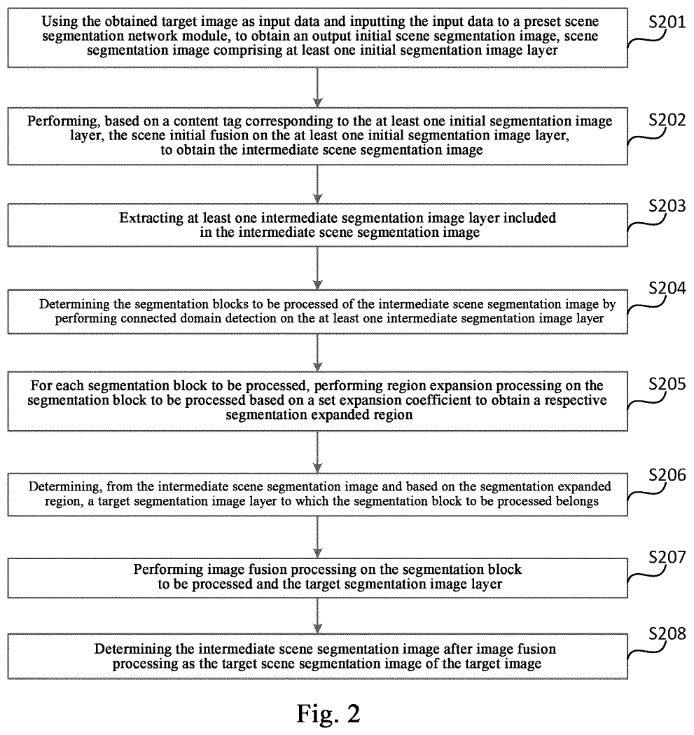

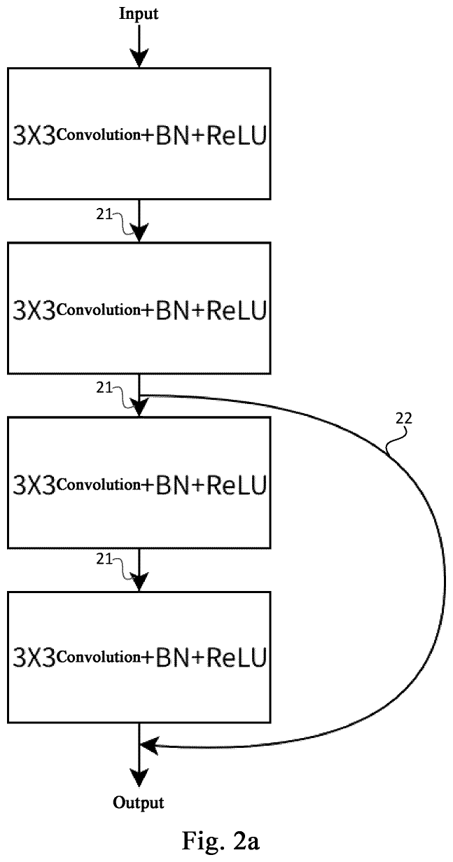

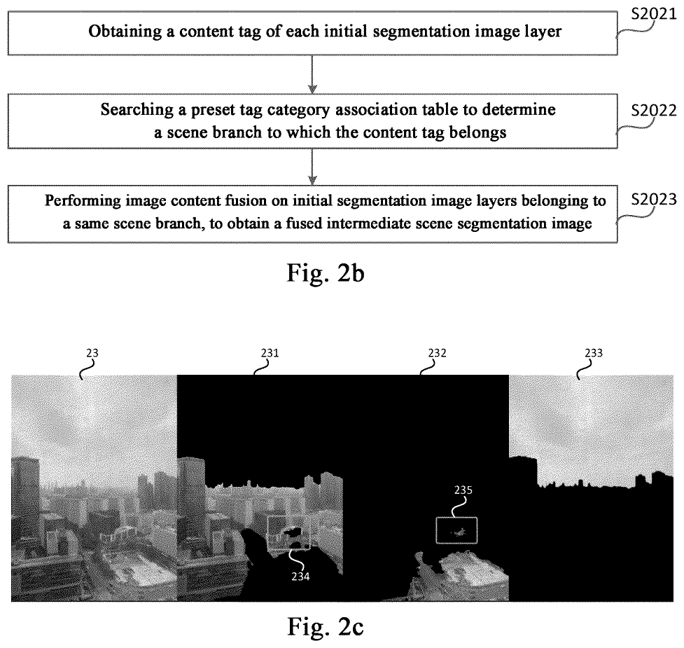

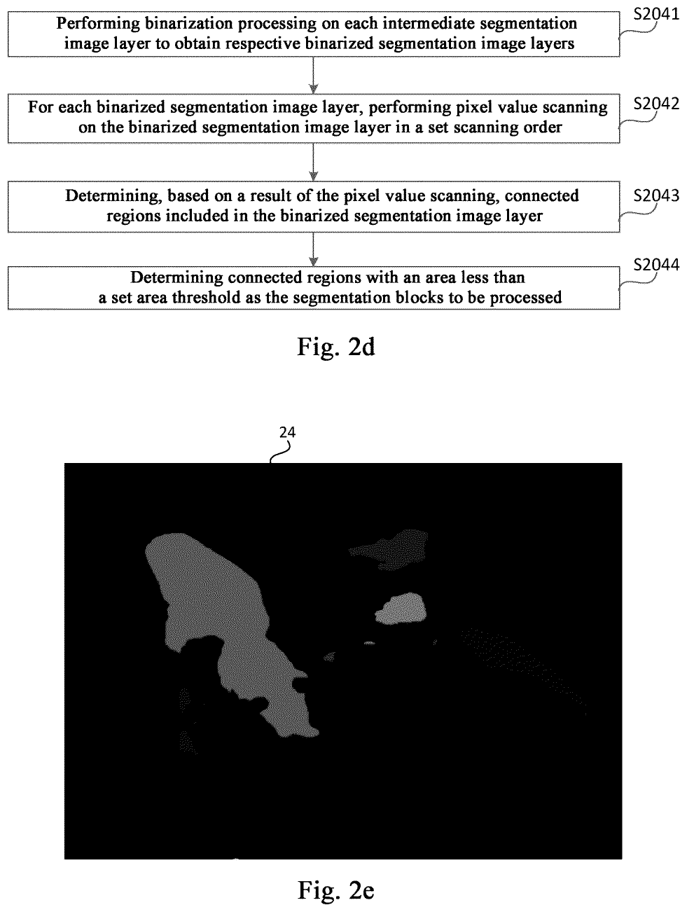

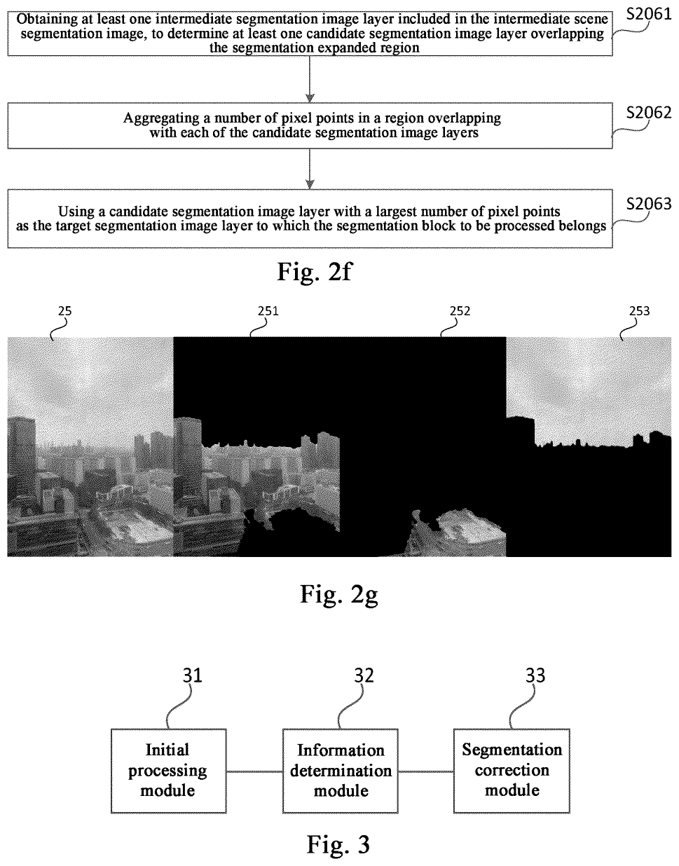

FIG. 2 illustrates a flowchart of an image scene segmentation method provided by the Embodiment II of the present disclosure. On the basis of any optional technical solution according to the embodiment of the present disclosure, alternatively, obtaining the intermediate scene segmentation image by performing the scene initial segmentation and the scene initial fusion on the obtained target image, according to this embodiment, may be instantiated as follows: using the obtained target image as input data and inputting the input data to a preset scene segmentation network module, to obtain an output initial scene segmentation image, scene segmentation image comprising at least one initial segmentation image layer; and performing, based on a content tag corresponding to the at least one initial segmentation image layer, the scene initial fusion on the at least one initial segmentation image layer, to obtain the intermediate scene segmentation image.

Alternatively, detecting, from the intermediate scene segmentation image, the segmentation blocks to be processed, according to the embodiment, may be instantiated as follows: extracting at least one intermediate segmentation image layer included in the intermediate scene segmentation image; and determining the segmentation blocks to be processed of the intermediate scene segmentation image by performing connected domain detection on the at least one intermediate segmentation image layer.

In addition, alternatively, obtaining the target scene segmentation image of the target image by performing the segmentation correction on the segmentation blocks to be processed, according to this embodiment, may be instantiated as follows: for each segmentation block to be processed, expanding regions of the segmentation block to be processed based on a set expansion coefficient to obtain a respective segmentation expanded region; determining, from the intermediate scene segmentation image and based on the segmentation expanded region, a target segmentation image layer to which the segmentation block to be processed belongs; performing image fusion processing on the segmentation block to be processed and the target segmentation image layer; and determining the intermediate scene segmentation image after image fusion processing as the target scene segmentation image of the target image.

As shown in FIG. 2, the image scene segmentation method provided by the Embodiment II includes steps of:

S201: using the obtained target image as input data and inputting the input data to a preset scene segmentation network module, to obtain an output initial scene segmentation image, scene segmentation image comprising at least one initial segmentation image layer.

In the embodiment, the step provides a logical implementation of scene initial segmentation. By way of example, in the step, scene initial segmentation is performed mainly using a given scene segmentation network model, where the target image can be used directly as input data to be input to the scene segmentation initial segmentation network model. The scene segmentation network model can be considered as a pre-built neural network model having a specific network structure, and the neural network model can form the scene segmentation network model used in the step after subjected to iterative learning and training using a preset training sample set. The scene segmentation network model can output an initial scene segmentation image including at least one initial segmentation image layer after performing feature extraction on the input target image and performing computing processing based on network parameters.

It is to be appreciated that the initial segmentation image layer in the initial scene segmentation image includes image contents in the same scene category. In order to better differentiate at least one initial segmentation image layer included in the initial scene segmentation image, different segmentation image layers are assigned with different colors.

In the embodiment, the scene segmentation network model can be considered as a general scene segmentation model, i.e., it can be applied to various application scenarios in the service applications. In addition to an input layer and an output layer, the scene segmentation network model may further include a hidden layer actually participating in scene segmentation processing. Alternatively, the hidden layer of the scene segmentation network model includes a set number of residual sub-network models; the set number of residual sub-network models are connected sequentially in a hierarchical order, and there simultaneously exists a residual connection from a residual sub-network model to a further non-adjacent residual sub-network model; and each residual sub-network model includes a convolutional layer, a batch normalization layer and a nonlinear activation function layer.

In the embodiment, a convolution kernel used by the convolutional layer in the residual sub-network model may be a 3×3 convolutional kernel; the nonlinear activation function used may be a ReLU function; in addition, there exists a residual connection, in addition to the sequential connection between the residual sub-network models. When the scene segmentation network model has a relatively deep network structure, the above connection is more beneficial for training the network model.

By way of example, FIG. 2a illustrates a structural schematic diagram of a scene segmentation network model utilized for scene initial segmentation in the image scene segmentation method provided by the Embodiment II of the present disclosure. As shown therein, the scene segmentation network model includes a plurality of residual network ResNet basic units, where each ResNet basic unit is comprised of a convolutional layer with a 3×3 convolutional kernel, a batch normalization (BN batchnorm) layer, and an ReLU (a nonlinear activation function), a straight connection path 21 is included between respective ResNet basic units, and additional residual connection paths 22 are also provided. The network model formed by the ResNet basic units employed in the present embodiment acts as a major part for image scene segmentation, and the scene segmentation image in the target image can be computed by feature extraction.

S202: performing, based on a content tag corresponding to the at least one initial segmentation image layer, the scene initial fusion on the at least one initial segmentation image layer, to obtain the intermediate scene segmentation image.

In the embodiment, this step provides a logical implementation of scene initial fusion. Wherein, the initial segmentation image layer can be considered as the segmentation image layer in the initial scene segmentation image obtained in step S201 as mentioned above; each of the initial segmentation image layers includes image contents in the same scene category; the content tag can be considered as a scene category tag of the initial segmentation image layer, for identifying a scene category of the image contents included in the scene segmentation image; the content tag can be obtained simultaneously upon obtaining the initial scene segmentation image.

Through the above analysis in the embodiment, it could be learned that the scene categories segmented from the initial scene segmentation image are relatively diverse and differ in granularity. It is possible that a certain scene category is actually smaller than a further scene category in scale. However, if the scene categories are divided too finely, the corresponding segmentation result may not match the application scenario corresponding to the image scene segmentation, making it impossible to guarantee the validity of the obtained segmentation result.

By way of example, it is assumed that the actual segmentation applying scenario in the service application is to segment a building complex from the ground and sky, but the respective content tags in the obtained initial scene segmentation image include flower, grass and tree. In the case, the segmentation result does not match the segmentation applying scenario as required. Through analysis, it could be learned that the flowers, grasses and trees are plants that grow on the ground, which should be part of the ground. In order to obtain more accurate segmentation result, it is required to perform scene fusion processing according to the step.

The scene fusion processing in the step can be implemented based on the content tags of the initial segmentation image layer. By way of example, the execution logic includes: setting a corresponding scene category fusion rule according to the application scenario; then determining a plurality of content tags meeting the scene category fusion rule, and fusing the segmentation image layers corresponding thereto, to form new segmentation layers; after completing scene fusion, forming an intermediate scene segmentation image based on the segmentation image layers formed after fusion processing.

Alternatively, FIG. 2b illustrates a flowchart of image fusion processing in the image scene segmentation method provided by the Embodiment II of the present disclosure. As shown in FIG. 2b, on the basis of the above embodiment, performing, based on the content tag corresponding to the at least one initial segmentation image layer, the scene initial fusion on the at least one initial segmentation image layer, to obtain the intermediate scene segmentation image, according to the present embodiment, includes:

S2021: obtaining a content tag of each initial segmentation image layer.

In the embodiment, the content tag of each initial segmentation image layer can be extracted from the obtained initial scene segmentation image.

S2022: searching a preset tag category association table to determine a scene branch to which the content tag belongs.

In the embodiment, the tag category association table is a preset information rule table, which can be set depending on the current application scenario. Through analysis of the application scenario requirements, those skilled in the art can determine a plurality of scene branches matching the application scenario, where a plurality of content tags with belonging or parallel relationships may be included in different scene branches.

By way of example, assumed that a scene branch is ground, in an application scenario, the content tags associated with the scene branch include at least: ground, flower, grass, tree and the like. Therefore, in the tag category association table set for the application scenario, one record therein can indicate that the content tags such as flower, grass, tree and ground all belong to the scene branch of ground. In the embodiment, after obtaining the content tag of each initial segmentation image layer, the scene branch associated with each content tag can be obtained by searching the tag category association table according to the step.

S2023: performing image content fusion on initial segmentation image layers belonging to a same scene branch, to obtain a fused intermediate scene segmentation image.

Continuing with the above example description, assumed that it is determined that ground, flower, grass and tree are all belong to the scene branch of ground, scene initial fusion can be performed on the initial segmentation image layers respectively corresponding to the ground, flower, grass and tree in the initial scene segmentation image, and the intermediate scene segmentation image can be obtained finally through the step.

S203 and S204 of the embodiment, as will be described later, provide a logical implementation of detecting segmented blocked to be processed.

By way of example, FIG. 2c illustrates a rendering of an intermediate scene segmentation image determined in the image scene segmentation method provided by the Embodiment II of the present disclosure. As shown therein, to display more details of the intermediate scene segmentation image, FIG. 2c shows the intermediate scene segmentation image 23 and a plurality of intermediate segmentation layers included in the intermediate scene segmentation image 23, from which it can be seen that: a building complex is mainly embodied in the first image layer 213; the ground is mainly embodied in the second image layer 232; and the sky is mainly embodied in the third image layer 233.

S203: extracting at least one intermediate segmentation image layer included in the intermediate scene segmentation image.

After obtaining the intermediate scene segmentation image in the S202, which is equivalent to that the intermediate scene segmentation layers included therein have been obtained, the at least one intermediate segmentation image layer is extracted in the step.

S204: determining the segmentation blocks to be processed of the intermediate scene segmentation image by performing connected domain detection on the at least one intermediate segmentation image layer.

In the embodiment, the connected domain detection according to the step can be implemented through a set connected domain detection algorithm, where the core of the connected domain detection algorithm can include: performing pixel scanning on the image after the binarization processing, to determine whether the pixels are located in the same region and further determine the connected region in the intermediate segmentation image layer; then searching the abnormally segmented segmentation blocks to be processed based on the areas of the connected regions.

FIG. 2d illustrates a flowchart of determining segmentation blocks to be processed in the image scene segmentation method provided by the Embodiment II of the present disclosure. As shown therein, on the basis of the above embodiment, alternatively, determining segmentation blocks of the intermediate scene segmentation image by performing connected region detection on the at least one intermediate segmentation image layer, according to the present embodiment, may be instantiated as steps of:

S2041: performing binarization processing on each intermediate segmentation image layer to obtain respective binarized segmentation image layers.

By way of example, the binarization processing can include assigning a pixel value of 0 or 1 to pixels in the intermediate segmentation image layer.

S2042: for each binarized segmentation image layer, performing pixel value scanning on the binarized segmentation image layer in a set scanning order.

By way of example, the scanning order of the pixels may be from left to right and from top to bottom; and pixel values of the pixels can be determined through the scanning step.

S2043: determining, based on a result of the pixel value scanning, connected regions included in the binarized segmentation image layer.

By way of example, the connected region detection based on pixel values according to the present embodiment can be performed during the pixel value scanning, and the connected region detection may be described as follows: assumed that the pixel value of the current pixel being scanned is 0, moving to a next pixel according to the scanning order; assumed that the pixel value of the current pixel being scanned is 1, detecting two adjacent pixels respectively located at the left and the upper side of the current pixel, and then taking the following 4 cases into consideration based on the pixel values and the detection tags of the two adjacent pixels:
1) the pixel values of the two adjacent pixels are both 0. At this time, the current pixel is given a new tag (indicating a start of a new connected region);
2) only one of the pixel values of the two adjacent pixels is 1. At this time, the tag of the current pixel is the same as the tag of the one having the pixel value of 1 in the two adjacent pixels;
3) the pixel values of the two adjacent pixels are both 1. At this time, the tag of the current pixel is also the tag; and
4) the two adjacent pixels both have the pixel value of 1 but differ in tag. A smaller tag in the tags of the two adjacent pixels is assigned to the current pixel.

Continuing with the above description, after the pixel scanning is completed, by means of the tag corresponding to each pixel, the regions with the same tag can be seen as a connected region, and through the above operation, it can be determined that at least one connected region is included in the embodiment.

S2044: determining connected regions with an area less than a set area threshold as the segmentation blocks to be processed.

In the embodiment, the regional area of the at least one connected region can be determined, where the regional area can be characterized by a number of pixel values. As described above, during scene segmentation, the abnormally segmented segmentation block is typically embodied as an independent segmentation block with a small regional area. Therefore, in the step, the connected regions with an area less than a set area threshold can be used as the segmentation blocks to be processed.

By way of example, continuing with the description with reference to FIG. 2c, the segmentation blocks to be processed can be determined in a plurality of intermediate segmentation image layers through the connected domain detection, for example, a connected region within a first rectangular block 234 in the first image layer 231, and a connected region within a second rectangular block 235 in the second image 232, which is equivalent to determining segmentation blocks to be processed.

FIG. 2e illustrates an example rendering of displaying the determined segmentation blocks to be processed in the same image according to the Embodiment II of the present disclosure. As shown therein, the image 24 includes a plurality of detected segmentation blocks to be processed in the corresponding intermediate segmentation image 23 in FIG. 2c, and different color values can be used to color the pixels in the segmented blocks to be processed, in order to better identify the plurality of segmentation blocks to be processed.

Steps 205 and S206 of the present embodiment, as will be described later, provide a specific implementation of performing segmentation correction on the segmentation blocks to be processed.

S205: for each segmentation block to be processed, expanding regions of the segmentation block to be processed based on a set expansion coefficient to obtain a respective segmentation expanded region.

In the present embodiment, the set expansion coefficient may be a matrix of all 1s with a convolutional kernel of 3×3, where the segmentation block to be processed participating in expansion is an expansion center; then, the segmentation block to be processed is expanded peripherally according to the matrix of all Is with the convolutional kernel of 3×3, where the expanded region is marked as a segmentation expanded region in the embodiment. Wherein, the segmentation expanded region may be a peripherally expanded region excluding the segmentation block to be processed, or may include a fusion of the segmentation block to be processed and the peripherally expanded region.

S206: determining, from the intermediate scene segmentation image and based on the segmentation expanded region, a target segmentation image layer to which the segmentation block to be processed belongs.

It would be appreciated that the segmentation expanded region corresponding to the detected segmentation block to be processed may overlap with any intermediate segmentation image layer in the intermediate scene segmentation image, and to what intermediate segmentation image layer the segmentation block to be processed belongs can be determined based on an overlapping proportion of the segmentation expanded region and the any intermediate segmentation layer.

Alternatively, FIG. 2f illustrates a flowchart of determining a segmentation layer to which the segmentation blocks to be processed belong in the image scene segmentation method provided by the Embodiment II of the present disclosure. As shown therein, on the basis of the above embodiment, determining, from the intermediate scene segmentation image and based on the segmentation expanded region, the target segmentation image layer to which the segmentation blocks to be processed belong, according to the present embodiment, may be instantiated as steps of:

S2061: obtaining at least one intermediate segmentation image layer included in the intermediate scene segmentation image, to determine at least one candidate segmentation image layer overlapping the segmentation expanded region.

By way of example, based on pixel positions of a plurality of pixel points included in the segmentation expanded region and pixel positions of image contents included in the at least one intermediate segmentation image layer, which intermediate segmentation image layers have overlaps with the segmentation expanded region can be determined, where the intermediate segmentation image layers with the overlaps are marked as candidate segmentation image layers.

S2062: aggregating a number of pixel points in a region overlapping with each of the candidate segmentation image layers.

S2063: using a candidate segmentation image layer with a largest number of pixel points as the target segmentation image layer to which the segmentation block to be processed belongs.

In this embodiment, the largest number of pixels is equivalent to that the segmentation expanded region has the largest number of overlapping pixels in the target segmentation image layer.

S207: performing image fusion on the segmentation block to be processed and the target segmentation image layer.

It is to be appreciated that alternatively, pixel points corresponding to a plurality of image contents in the same segmentation image layer have the same pixel value in the present embodiment. By way of example, an image fusion approach can be described as equating pixel values of a plurality of pixel points in the segmentation block to be processed to pixel values of pixel points in the target segmentation image layer.

S208: using the fused intermediate segmentation image as the target scene segmentation image of the target image.

In the embodiment, the fusion processing in the step is equivalent to scene-fusing the segmentation block to be processed with the target segmentation image layer when performing segmentation correction. Therefore, abnormal segmentation repair of the segmentation block to be processed can be implemented, and the number of fragmented segmentation blocks on at least one segmentation image layer in the ultimately obtained target scene segmentation image can be obviously reduced.

By way of example, FIG. 2g illustrates a rendering of a target scene segmentation image in the image scene segmentation method provided by the Embodiment II of the present disclosure. As shown therein, for better understanding of the details of the target scene segmentation image, the rendering corresponds to FIG. 2c, where FIG. 2g shows the target scene segmentation image 25 and a plurality of target segmentation image layers included in the target scene segmentation image 25, from which it could be seen that: a building complex is mainly embodied in the fourth image layer 251; the ground is mainly embodied in the fifth image layer 252; and the sky is mainly embodied in the sixth image layer 256.

Through comparison of FIG. 2g with FIG. 2c, it could be found that the fragmented segmentation blocks in the second rectangular bock 235 in the second image layer 232 in FIG. 2c is finally fused into the fourth image layer 251 in FIG. 2g by segmentation correction, to achieve completeness of the building complex scene and thus attain the accuracy of the ground scene in the fifth layer 252 in FIG. 2g.

The image scene segmentation method provided by the Embodiment II includes performing, by a scene segmentation network module, scene initial segmentation on an image and scene initial fusion on the initial segmentation result to implement first segmentation result processing. Meanwhile, the image scene segmentation method provides a specific implementation of detecting segmentation blocks to be processed, and a specific implementation of performing segmentation correction on the segmentation blocks to be processed. The method provided by this embodiment can solve the problem that the image scene segmentation method in the related technologies cannot implement accurate segmentation, but typically generate fragmented segmentation results. Different from the legacy improvement solution, the key to the solution provided by the present embodiment is to perform fragmentation detection on the segmentation result after performing the image scene segmentation, and perform segmentation correction on the detected fragmented segmentation blocks. The corrected segmentation result shows that the present disclosure has the advantageous effect of segmenting image contents in the same scene category in the target image in a concentrated manner, reducing fragmented segmentation blocks, and effectively improving accuracy of the segmentation result.

### Embodiment III

FIG. 3 is a structural schematic diagram of an image scene segmentation apparatus provided by an Embodiment III of the present disclosure. The present embodiment can be applied to segment an obtained image, and the apparatus can be implemented by software and/or hardware and configured in a terminal and/or server to implement the image scene segmentation method according to embodiments of the present disclosure. The apparatus may include: an initial processing module 31, an information determination module 32 and a segmentation correction module 33.

Wherein, the initial processing module 31 is configured to obtain an intermediate scene segmentation image by performing scene initial segmentation and scene initial fusion on an obtained target image;
the information determining module 32 is configured to detect, from the intermediate scene segmentation image, segmentation blocks to be processed; and
the segmentation correction module 33 is configured to obtain a target scene segmentation image of the target image by performing segmentation correction on the segmentation blocks to be processed.

The image scene segmentation apparatus provided by the Embodiment III can solve the problem that the image scene segmentation method in the related technologies cannot implement accurate segmentation, but typically generate fragmented segmentation results. Different from the legacy improvement solution, the key to the solution provided by the present embodiment is to perform fragmentation detection on the segmentation result after performing the image scene segmentation, and perform segmentation correction on the detected fragmented segmentation blocks. The corrected segmentation result shows that the present disclosure has the advantageous effect of segmenting image contents in the same scene category in the target image in a concentrated manner, reducing fragmented segmentation blocks, and effectively improving accuracy of the segmentation result.

On the basis of any optional technical solution according to embodiments of the present disclosure, alternatively, the initial processing module 31 includes:
an initial segmentation unit configured to use the obtained target image as input data and input the input data to a preset scene segmentation network module, to obtain an output initial scene segmentation image, scene segmentation image comprising at least one initial segmentation image layer; and
an initial fusion unit configured to perform, based on a content tag corresponding to the at least one initial segmentation image layer, the scene initial fusion on the at least one initial segmentation image layer, to obtain the intermediate scene segmentation image.

On the basis of any optional technical solution according to embodiments of the present disclosure, alternatively, the initial fusion unit may be configured to:
obtain a content tag of each initial segmentation image layer; search a preset tag category association table to determine a scene branch to which the content tag belongs; and perform image content fusion on initial segmentation image layers belonging to a same scene branch, to obtain a fused intermediate scene segmentation image.

On the basis of any optional technical solution according to embodiments of the present disclosure, alternatively, a hidden layer of the scene segmentation network model includes a set number of residual sub-network models; the set number of residual sub-network models are connected sequentially in a hierarchical order, and there simultaneously exists a residual connection from a residual sub-network model to a further non-adjacent residual sub-network model; and each residual sub-network model comprises a convolutional layer, a batch normalization layer and a nonlinear activation function layer.

On the basis of any optional technical solution according to embodiments of the present disclosure, alternatively, the information determining module 32 may include:
an information extraction unit configured to extract at least one intermediate segmentation image layer included in the intermediate scene segmentation image; and
an information determining unit configured to determine the segmentation blocks to be processed of the intermediate scene segmentation image by performing connected domain detection on the at least one intermediate segmentation image layer.

On the basis of any optional technical solution according to embodiments of the present disclosure, alternatively, the information determining unit may be configured to: perform binarization processing on each intermediate segmentation image layer to obtain respective binarized segmentation image layers; for each binarized segmentation image layer, perform pixel value scanning on the binarized segmentation image layer in a set scanning order; determine, based on a result of the pixel value scanning, connected regions included in the binarized segmentation image layer; and determine connected regions with an area less than a set area threshold as the segmentation blocks to be processed.

On the basis of any optional technical solution according to embodiments of the present disclosure, alternatively, the segmentation correction module may include:
a region determining unit configured, for each segmentation block to be processed, to perform area expansion processing on the segmentation block to be processed based on a set expansion coefficient to obtain a respective segmentation expanded region;
a first correction unit configured to determine, from the intermediate scene segmentation image and based on the segmentation expanded region, a target segmentation image layer to which the segmentation block to be processed belongs;
a second correction unit configured to perform image fusion processing on the segmentation block to be processed and the target segmentation image layer; and
a target determining unit configured to determine the intermediate scene segmentation image after image fusion processing as the target scene segmentation image of the target image.

On the basis of any optional technical solution according to embodiments of the present disclosure, alternatively, the second correction unit may be configured to:
obtain at least one intermediate segmentation image layer included in the intermediate scene segmentation image to determine at least one candidate segmentation image layer overlapping the segmentation expanded region; aggregate a number of pixel points in a region overlapping each candidate segmentation image layer; and determine a candidate segmentation image layer corresponding to a largest number of pixel points as the target segmentation image layer to which the segmentation block to be processed belongs.

The above apparatus can execute the method provided by any embodiment of the present disclosure and include corresponding functional modules for executing the method.

It is worth noting that units and modules involved in the embodiments of the mode configuration apparatus are divided according to functional logic, and the division is not limited to this as long as the corresponding functions can be implemented. In addition, the specific names of functional units are employed for differentiation, not to limiting the scope of the present disclosure.

### Embodiment IV

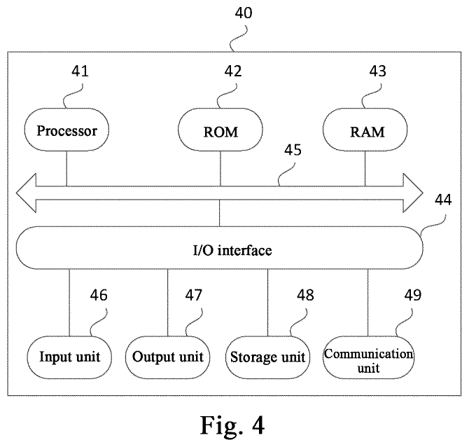

FIG. 4 is a structural schematic diagram of an electronic device provided by an Embodiment VII of the present disclosure. Reference below will be made to FIG. 4 which illustrates a structural schematic diagram of an electronic device (e.g. a terminal device or a server in FIG. 4) 40 adapted to implement embodiments of the present disclosure. The terminal device according to the embodiments of the present disclosure may include, but is not limited to, a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital TV, a desktop computer or the like. The electronic device as shown in FIG. 4 is provided merely as an example, without suggesting any limitation to the functions and the application range of the embodiments of the present disclosure.

As shown therein, the electronic device 40 may include a processor (e.g. a central processor, a graphics processor or the like) 41, which can execute various acts and processing based on programs stored in a Read Only Memory (ROM) 42 or a program loaded from a storage unit 48 to a Random Access Memory (RAM) 43. RAM 43 stores therein various programs and data required for operations of the electronic device 40. The processor 41, the ROM 42 and the RAM 43 are connected to one another via a bus 45. An input/output (I/O) interface 44 is also connected to the bus 45.

Typically, the following units may be connected to the I/O interface 44: an input unit 406 including, for example, a touchscreen, a touch pad, a keyboard, a mouse, a camera, a microphone, an accelerometer, a gyroscope and the like; an output unit 47 including, for example, a Liquid Crystal Display (LCD), a loudspeaker, a vibrator and the like; a storage unit 48 including, for example, a tape, a hard drive and the like; and a communication unit 49. The communication unit 49 can allow wireless or wired communication of the electronic device 40 with other devices to exchange data. Although FIG. 4 shows the electronic device 40 including various units, it would be appreciated that not all of the units as shown are required to be implemented or provided. Alternatively, more or fewer units may be implemented or provided.

In particular, according to embodiments of the present disclosure, the processes described above with reference to the flowcharts may be implemented as computer software programs. For example, embodiments of the present disclosure include a computer program product comprising a computer program carried on a computer readable medium, the computer program containing program code for performing the image processing method according to the present disclosure. In those embodiments, the computer program may be downloaded and installed from a network via the communication unit 49, or may be installed from the storage unit 48, or may be installed from the ROM 42. The computer program, when executed by the processor 41, performs the above-described functions defined in the method according to the embodiments of the present disclosure.

Names of messages or information interacted between a plurality of apparatuses in the embodiments of the present disclosure are illustrative rather than limit the scope of the message or information.

The electronic device provided by the present embodiment of the present disclosure and the image scene segmentation method provided by the above-mentioned embodiments belong to the same invention idea. See the above embodiments for technical details not described in this embodiment.

### Embodiment V

Embodiments of the present disclosure provide a computer storage medium having computer programs stored thereon, which implement the image scene segmentation method provided by the above embodiments when executed by a processor.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries at least one program which, when executed by the electronic device, causes the electronic device to:
obtain an intermediate scene segmentation image by performing scene initial segmentation and scene initial fusion on an obtained target image;
detect, from the intermediate scene segmentation image, segmentation blocks to be processed; and
obtain a target scene segmentation image of the target image by performing segmentation correction on the segmentation blocks to be processed.

Computer program codes for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the functionality and operation of possible implementations of methods, apparatus and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

The units described in the embodiments of the present disclosure may be implemented by software or hardware. Wherein, the designation of a module or unit does not in some cases constitute a limitation of the unit itself. For example, the first obtaining unit may also be described as “a unit for obtaining at least two Internet Protocol addresses.”

The functions described above may be performed, at least in part, by one or more hardware logic components. For example, without limitation, example types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to at least one embodiment of the present disclosure, [Example I] provides an image scene segmentation method, comprising: obtaining an intermediate scene segmentation image by performing scene initial segmentation and scene initial fusion on an obtained target image; detecting, from the intermediate scene segmentation image, segmentation blocks to be processed; and obtaining a target scene segmentation image of the target image by performing segmentation correction on the segmentation blocks to be processed.

According to at least one embodiment of the present disclosure, [Example II] provides an image scene segmentation method, where the step of obtaining an intermediate scene segmentation image by performing the scene initial segmentation and the scene initial fusion on the obtained target image optionally comprises: using the obtained target image as input data and inputting the input data to a preset scene segmentation network module, to obtain an output initial scene segmentation image, scene segmentation image comprising at least one initial segmentation image layer; and performing, based on a content tag corresponding to the at least one initial segmentation image layer, the scene initial fusion on the at least one initial segmentation image layer, to obtain the intermediate scene segmentation image.

According to at least one embodiment of the present disclosure, [Example III] provides an image scene segmentation method, where the step of performing, based on the content tag corresponding to the at least one initial segmentation image layer, the scene initial fusion on the at least one initial segmentation image layer, to obtain the intermediate scene segmentation image optionally comprises: obtaining a content tag of each initial segmentation image layer; searching a preset tag category association table to determine a scene branch to which the content tag belongs; and performing image content fusion on initial segmentation image layers belonging to a same scene branch, to obtain a fused intermediate scene segmentation image.

According to at least one embodiment of the present disclosure, [Example IV] provides an image scene segmentation method, optionally comprises: a hidden layer of the scene segmentation network model comprises a set number of residual sub-network models; the set number of residual sub-network models are connected sequentially in a hierarchical order, and there simultaneously exists a residual connection from a residual sub-network model to a further non-adjacent residual sub-network model; and each residual sub-network model comprises a convolutional layer, a batch normalization layer and a nonlinear activation function layer.

According to at least one embodiment of the present disclosure, [Example V] provides an image scene segmentation method, where the step of detecting, from the intermediate scene segmentation image, the segmentation blocks to be processed optionally comprises: extracting at least one intermediate segmentation image layer included in the intermediate scene segmentation image; and determining the segmentation blocks to be processed of the intermediate scene segmentation image by performing connected domain detection on the at least one intermediate segmentation image layer.

According to at least one embodiment of the present disclosure, [Example VI] provides an image scene segmentation method, where the step of determining the segmentation blocks to be processed of the intermediate scene segmentation image by performing the connected domain detection on the at least one intermediate segmentation image layer comprises: performing binarization processing on each intermediate segmentation image layer to obtain respective binarized segmentation image layers; for each binarized segmentation image layer, performing pixel value scanning on the binarized segmentation image layer in a set scanning order; determining, based on a result of the pixel value scanning, connected regions included in the binarized segmentation image layer; and determining connected regions with an area less than a set area threshold as the segmentation blocks to be processed.

According to at least one embodiment of the present disclosure, [Example VII] provides an image scene segmentation method, where the step of obtaining the target scene segmentation image of the target image by performing the segmentation correction on the segmentation blocks to be processed optionally comprises: for each segmentation block to be processed, performing region expansion processing on the segmentation block to be processed based on a set expansion coefficient to obtain a respective segmentation expanded region; determining, from the intermediate scene segmentation image and based on the segmentation expanded region, a target segmentation image layer to which the segmentation block to be processed belongs; performing image fusion processing on the segmentation block to be processed and the target segmentation image layer; and determining the intermediate scene segmentation image after image fusion processing as the target scene segmentation image of the target image.

According to at least one embodiment of the present disclosure, [Example VIII] provides an image scene segmentation method, where the step of determining, from the intermediate scene segmentation image and based on the segmentation expanded region, the target segmentation image layer to which the segmentation block to be processed belongs optionally comprises: obtaining at least one intermediate segmentation image layer included in the intermediate scene segmentation image to determine at least one candidate segmentation image layer overlapping the segmentation expanded region; determining a number of pixel points in a region overlapping each candidate segmentation image layer; and determining a candidate segmentation image layer corresponding to a largest number of pixel points as the target segmentation image layer to which the segmentation block to be processed belongs.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

What is claimed is:

1. A image scene segmentation method, comprising:
obtaining an intermediate scene segmentation image by performing scene initial segmentation and scene initial fusion on an obtained target image;
detecting, from the intermediate scene segmentation image, segmentation blocks to be processed; and
obtaining a target scene segmentation image of the target image by performing segmentation correction on the segmentation blocks to be processed.

2. The method of claim 1, wherein obtaining the intermediate scene segmentation image by performing the scene initial segmentation and the scene initial fusion on the obtained target image comprises:
using the obtained target image as input data and inputting the input data to a preset scene segmentation network module, to obtain an output initial scene segmentation image, scene segmentation image comprising at least one initial segmentation image layer; and
performing, based on a content tag corresponding to the at least one initial segmentation image layer, the scene initial fusion on the at least one initial segmentation image layer, to obtain the intermediate scene segmentation image.

3. The method of claim 2, wherein performing, based on the content tag corresponding to the at least one initial segmentation image layer, the scene initial fusion on the at least one initial segmentation image layer, to obtain the intermediate scene segmentation image, comprises:
obtaining a content tag of each initial segmentation image layer;
searching a preset tag category association table to determine a scene branch to which the content tag belongs; and
performing image content fusion on initial segmentation image layers belonging to a same scene branch, to obtain a fused intermediate scene segmentation image.

4. The method of claim 2, wherein a hidden layer of the scene segmentation network model comprises a set number of residual sub-network models;
a set number of residual sub-network models are connected sequentially in a hierarchical order, and there simultaneously exists a residual connection from a residual sub-network model to a further non-adjacent residual sub-network model; and
each residual sub-network model comprises a convolutional layer, a batch normalization layer and a nonlinear activation function layer.

5. The method of claim 1, wherein detecting, from the intermediate scene segmentation image, the segmentation blocks to be processed comprises:
extracting at least one intermediate segmentation image layer included in the intermediate scene segmentation image; and
determining the segmentation blocks to be processed of the intermediate scene segmentation image by performing connected domain detection on the at least one intermediate segmentation image layer.

6. The method of claim 5, wherein determining the segmentation blocks to be processed of the intermediate scene segmentation image by performing the connected domain detection on the at least one intermediate segmentation image layer comprises:
performing binarization processing on each intermediate segmentation image layer to obtain respective binarized segmentation image layers;
for each binarized segmentation image layer, performing pixel value scanning on the binarized segmentation image layer in a set scanning order;
determining, based on a result of the pixel value scanning, connected regions included in the binarized segmentation image layer; and
determining connected regions with an area less than a set area threshold as the segmentation blocks to be processed.

7. The method of claim 1, wherein obtaining the target scene segmentation image of the target image by performing the segmentation correction on the segmentation blocks to be processed comprises:
for each segmentation block to be processed, performing area expansion processing on the segmentation block to be processed based on a set expansion coefficient to obtain a respective segmentation expanded region;
determining, from the intermediate scene segmentation image and based on the segmentation expanded region, a target segmentation image layer to which the segmentation block to be processed belongs;
performing image fusion processing on the segmentation block to be processed and the target segmentation image layer; and
determining the intermediate scene segmentation image after image fusion processing as the target scene segmentation image of the target image.

8. The method of claim 7, wherein determining, from the intermediate scene segmentation image and based on the segmentation expanded region, the target segmentation image layer to which the segmentation block to be processed belongs, comprises:
obtaining at least one intermediate segmentation image layer included in the intermediate scene segmentation image to determine at least one candidate segmentation image layer overlapping the segmentation expanded region;
determining a number of pixel points in a region overlapping each candidate segmentation image layer; and
determining a candidate segmentation image layer corresponding to a largest number of pixel points as the target segmentation image layer to which the segmentation block to be processed belongs.

9. (canceled)

10. An electronic device, comprising:
at least one processor; and
a memory storing at least one computer program;
wherein the at least one computer program, when executed by the at least one processor, causes the at least one processor to implement actions comprising:
obtaining an intermediate scene segmentation image by performing scene initial segmentation and scene initial fusion on an obtained target image;
detecting, from the intermediate scene segmentation image, segmentation blocks to be processed; and
obtaining a target scene segmentation image of the target image by performing segmentation correction on the segmentation blocks to be processed.

11. A non-transitory computer readable storage medium having computer programs stored thereon, wherein the computer programs, when executed by a processor, implement image scene segmentation method comprising:
obtaining an intermediate scene segmentation image by performing scene initial segmentation and scene initial fusion on an obtained target image;
detecting, from the intermediate scene segmentation image, segmentation blocks to be processed; and
obtaining a target scene segmentation image of the target image by performing segmentation correction on the segmentation blocks to be processed.

12. The electronic device of claim 10, wherein obtaining the intermediate scene segmentation image by performing the scene initial segmentation and the scene initial fusion on the obtained target image comprises:
using the obtained target image as input data and inputting the input data to a preset scene segmentation network module, to obtain an output initial scene segmentation image, scene segmentation image comprising at least one initial segmentation image layer; and
performing, based on a content tag corresponding to the at least one initial segmentation image layer, the scene initial fusion on the at least one initial segmentation image layer, to obtain the intermediate scene segmentation image.

13. The electronic device of claim 12, wherein performing, based on the content tag corresponding to the at least one initial segmentation image layer, the scene initial fusion on the at least one initial segmentation image layer, to obtain the intermediate scene segmentation image, comprises:
obtaining a content tag of each initial segmentation image layer;
searching a preset tag category association table to determine a scene branch to which the content tag belongs; and
performing image content fusion on initial segmentation image layers belonging to a same scene branch, to obtain a fused intermediate scene segmentation image.

14. The electronic device of claim 12, wherein a hidden layer of the scene segmentation network model comprises a set number of residual sub-network models;
a set number of residual sub-network models are connected sequentially in a hierarchical order, and there simultaneously exists a residual connection from a residual sub-network model to a further non-adjacent residual sub-network model; and
each residual sub-network model comprises a convolutional layer, a batch normalization layer and a nonlinear activation function layer.

15. The electronic device of claim 10, wherein detecting, from the intermediate scene segmentation image, the segmentation blocks to be processed comprises:
extracting at least one intermediate segmentation image layer included in the intermediate scene segmentation image; and
determining the segmentation blocks to be processed of the intermediate scene segmentation image by performing connected domain detection on the at least one intermediate segmentation image layer.

16. The electronic device of claim 15, wherein determining the segmentation blocks to be processed of the intermediate scene segmentation image by performing the connected domain detection on the at least one intermediate segmentation image layer comprises:
performing binarization processing on each intermediate segmentation image layer to obtain respective binarized segmentation image layers;
for each binarized segmentation image layer, performing pixel value scanning on the binarized segmentation image layer in a set scanning order;
determining, based on a result of the pixel value scanning, connected regions included in the binarized segmentation image layer; and
determining connected regions with an area less than a set area threshold as the segmentation blocks to be processed.

17. The non-transitory computer readable storage medium of claim 11, wherein obtaining the intermediate scene segmentation image by performing the scene initial segmentation and the scene initial fusion on the obtained target image comprises:
using the obtained target image as input data and inputting the input data to a preset scene segmentation network module, to obtain an output initial scene segmentation image, scene segmentation image comprising at least one initial segmentation image layer; and
performing, based on a content tag corresponding to the at least one initial segmentation image layer, the scene initial fusion on the at least one initial segmentation image layer, to obtain the intermediate scene segmentation image.

18. The non-transitory computer readable storage medium of claim 17, wherein performing, based on the content tag corresponding to the at least one initial segmentation image layer, the scene initial fusion on the at least one initial segmentation image layer, to obtain the intermediate scene segmentation image, comprises:
obtaining a content tag of each initial segmentation image layer;
searching a preset tag category association table to determine a scene branch to which the content tag belongs; and
performing image content fusion on initial segmentation image layers belonging to a same scene branch, to obtain a fused intermediate scene segmentation image.

19. The non-transitory computer readable storage medium of claim 17, wherein a hidden layer of the scene segmentation network model comprises a set number of residual sub-network models;
a set number of residual sub-network models are connected sequentially in a hierarchical order, and there simultaneously exists a residual connection from a residual sub-network model to a further non-adjacent residual sub-network model; and
each residual sub-network model comprises a convolutional layer, a batch normalization layer and a nonlinear activation function layer.

20. The non-transitory computer readable storage medium of claim 11, wherein detecting, from the intermediate scene segmentation image, the segmentation blocks to be processed comprises:
extracting at least one intermediate segmentation image layer included in the intermediate scene segmentation image; and
determining the segmentation blocks to be processed of the intermediate scene segmentation image by performing connected domain detection on the at least one intermediate segmentation image layer.

21. The non-transitory computer readable storage medium of claim 20, wherein determining the segmentation blocks to be processed of the intermediate scene segmentation image by performing the connected domain detection on the at least one intermediate segmentation image layer comprises:
performing binarization processing on each intermediate segmentation image layer to obtain respective binarized segmentation image layers;
for each binarized segmentation image layer, performing pixel value scanning on the binarized segmentation image layer in a set scanning order;
determining, based on a result of the pixel value scanning, connected regions included in the binarized segmentation image layer; and
determining connected regions with an area less than a set area threshold as the segmentation blocks to be processed.
